(19) United States
(12) Patent Application Publication
(10) Pub. No.: US 2013/0130559 A1
(43) Pub. Date: May 23, 2013

(54) CONNECTOR ASSEMBLY

(71) Applicant: YUN-LUNG CHEN, Tu-Cheng (TW)

(72) Inventor: YUN-LUNG CHEN, Tu-Cheng (TW)

(73) Assignee: HON HAI PRECISION INDUSTRY CO., LTD., Tu-Cheng (TW)

(21) Appl. No.: 13/532,800

(22) Filed: Jun. 26, 2012

(30) Foreign Application Priority Data
Nov. 22, 2011 (CN) 201110373603.2

(51) Int. Cl. H01R 24/00

(52) U.S. Cl. 439/660

(57) ABSTRACT

A connector assembly includes a plurality of connectors with a wire connecting rear ends of the connectors, and a frame receiving the connectors. The frame is made of insulated material. The frame has edges each defining a round corner to avoid harming the wire.

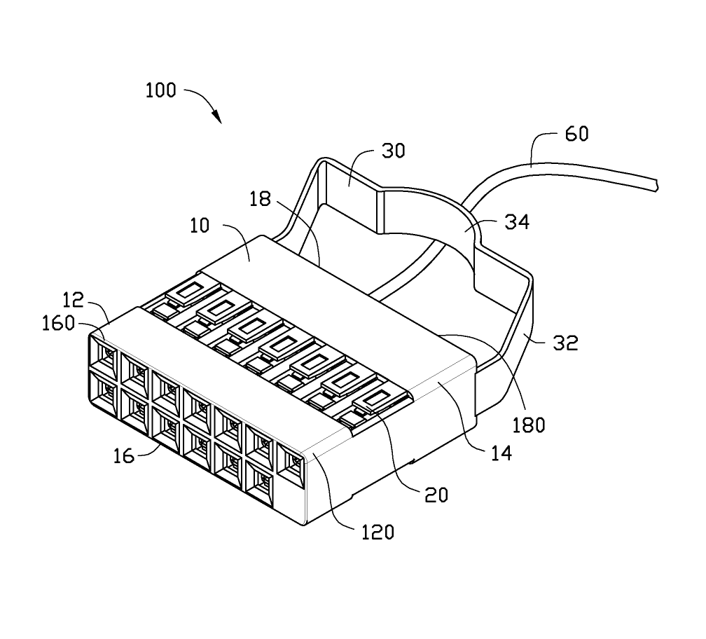

### BACKGROUND

1. Technical Field

The present disclosure relates to connector assemblies, more particularly, to a connector assembly for an electronic device.

2. Description of the Related Art

Connectors are used in computers and servers to transmit power or signals to peripheral devices. For different peripheral devices, the computers or servers often need different connectors, such as USB connector, IEEE 1394 connectors, and the like.

In related art, each of connectors includes a frame having sharp edges which easily harms wires connecting the connectors and easily harms user's hand. The connectors are usually cased in electrostatic bags. However, it results in complex and difficult assembly in use.

It is thus desirable to provide a connector assembly which can overcome the described limitations.

### BRIEF DESCRIPTION OF THE DRAWINGS

The components of the drawings are not necessarily drawn to scale, the emphasis instead being placed upon clearly illustrating the principles of the embodiments of the display device. Moreover, in the drawings, like reference numerals designate corresponding parts throughout several views.

The FIGURE is an isometric, assembled view of a connector assembly of an embodiment.

### DETAILED DESCRIPTION

Referring to the figure, a connector assembly 100 in accordance with an embodiment includes a frame 10, a plurality of connectors 20 received in the frame 10, and a handle 30 connecting the frame 10. The connectors 20 can be signal input and output connectors for audio and be inserted into an electronic device.

The frame 10 is made of insulated material such as plastic. The frame 10 has two left edges 12, two right edges 14, two front edges 16 and two rear edges 18. The left edges 12 and the right edges 14 are parallel to each other. Each of the left edges 12 and the right edges 14 defines a first round corner 120. The front edges 16 and the rear edges 18 are parallel to each other. Each of the front edges 16 defines a second round corner 160. Each of the rear edges 180 defines a third round corner 180. Each of the first round corners 120, the second round corners 160 and the third round corners 180 has a radius in a range of 0.1 mm to 0.5 mm. In this embodiment, a radian of each second round corner 160 is larger than a radian of each third round corner 180, and less than a radian of each first round corner 120. Since edges of the frame 10 define the first round corner 120, the second round corner 160 and the third corner 180, the frame 10 would not abrade electric wires 60 and user's handle. The frame 10 defines grooves (not labeled) therein to receive the connectors 20.

The handle 30 includes two connecting portions 32 respectively connecting rear ends of the frame 10, and an operating portion 34 connecting the connecting portions 32. In use, the handle 30 is pulled by user to disengage the connector assembly 100 from the electronic device. Therefore, the wire 60 can be protected when the connector assembly 100 is pulled from the electronic device.

It is to be further understood that even though numerous characteristics and advantages have been set forth in the foregoing description of the embodiment(s), together with details of the structures and functions of the embodiment(s), the disclosure is illustrative only; and that changes may be made in detail, especially in the matters of shape, size, and arrangement of parts within the principles of the disclosure to the full extent indicated by the broad general meaning of the terms in which the appended claims are expressed.

What is claimed is:

1. A connector assembly comprising:
a plurality of connectors with a wire connecting rear ends of the connectors; and
a frame receiving the connectors, the frame being made of insulated material, the frame having edges each defining a round corner to avoid harming the wire.

2. The connector assembly of claim 1, wherein the frame has two left edges, two right edges, two front edges and two rear edges, each of the left edges and the right edges defining a first round corner, each of the front edges defining a second round corner, each of the rear edges defining a third round corner, a radian of each second round corner being larger than a radian of each third round corner, and less than a radian of each first round corner.

3. The connector assembly of claim 1, wherein each of the first round corners, the second round corners and the third round corners has a radius in a range of 0.1 mm to 0.5 mm.

4. The connector assembly of claim 1, wherein the connector assembly further comprises a handle connecting a rear end of the frame.

5. The connector assembly of claim 4, wherein the handle comprises two connecting portions respectively connecting rear ends of the frame, and an operating portion connecting the connecting portions.

6. A connector assembly comprising:
a plurality of connectors with a wire connecting rear ends of the connectors;
a frame receiving the connectors, the frame having edges each defining a round corner to avoid harming the wire; and
a handle connecting rear ends of the frame.

7. The connector assembly of claim 6, wherein the frame has two left edges, two right edges, two front edges and two rear edges, each of the left edges and the right edges defining a first round corner, each of the front edges defining a second round corner, each of the rear edges defining a third round corner, a radian of each second round corner being larger than a radian of each third round corner, and less than a radian of each first round corner.

8. The connector assembly of claim 6, wherein each of the first round corners, the second round corners and the third round corners has a radius in a range of 0.1 mm to 0.5 mm.

9. The connector assembly of claim 6, wherein the handle comprises two connecting portions respectively connecting the rear ends of the frame, and an operating portion connecting the connecting portions.
